(19) United States
(12) Patent Application Publication
(10) Pub. No.: US 2014/0300748 A1
(43) Pub. Date: Oct. 9, 2014

(54) FIELD IR IMAGER

(71) Applicant: Universal Enterprises, Inc., Beaverton, OR (US)

(72) Inventors: Michael John Kane, Portland, OR (US); David Lauren Wheaton, Sherwood, OR (US); Sean Patrick Tierney, Milwaukie, OR (US)

(73) Assignee: Universal Enterprises, Inc., Beaverton, OR (US)

(21) Appl. No.: 14/206,346

(22) Filed: Mar. 12, 2014

Related U.S. Application Data
(60) Provisional application No. 61/800,207, filed on Mar. 15, 2013.

(51) Int. Cl. H04N 5/33; G06F 3/00

(52) U.S. Cl. CPC H04N 5/33; G06F 3/005
USPC 348/164

(57) ABSTRACT

A handheld-sized infrared thermal imaging device (i.e. IR camera) having a focal plane array (FPA) or other type of infrared sensor array, internal memory for storing saved thermal images, a mini-USB or other communications port, battery power supply, and minimal user interface options such as on/off, IR image capture, and potentially a very basic display. The IR camera provides a highly portable field usable thermal image capture instrument which can later be connected to an external computing device such as a laptop computer, with the computer software providing thermal imaging functionality typical of higher end thermal imaging cameras. A visual image camera may be added whereby corresponding visible and IR images are captured and downloadable to the external computer for subsequent thermal analysis.

### CROSS-REFERENCE TO RELATED APPLICATIONS

This application claims the benefit of U.S. provisional application Ser. No. 61/800,207 filed on Mar. 15, 2013, the entirety of which is incorporated herein by reference.

### BACKGROUND OF THE INVENTION

The technical field of the invention pertains generally to thermal imaging, and, more particularly, to low cost infrared camera and low cost thermal imaging instrument designs especially suited for field use to acquire thermal image data for targets such as residential or commercial HVAC/R systems, power distribution systems, electro-mechanical equipment, electronic circuit boards, and/or other thermal targets.

Existing methods and thermal imaging cameras for thermal analysis include the use of expensive thermal imaging cameras, which are made expensive due to complexities of the thermal imaging cameras themselves due to the way they are constructed, the methods used to capture and manipulate thermal and visible images, and complexities of on-board thermal analysis attempted with such thermal imaging cameras.

Attempts to provide a field usable portable thermal imaging camera include instruments that incorporate methods and apparatus reviewed and described in US pat. Publication U.S.2010/0045809, published Feb. 25, 2010 (hereinafter, the '809 application or, simply, '809), which is hereby incorporated by reference herein in its entirety. The '809 application discloses a handheld-sized thermal imaging camera multiple target-facing lenses and optics—a visible light lens, an infrared lens with circumferential focus ring, a laser pointer, and LED lights—and numerous rearward facing user interfaces—display, and numerous buttons. The '809 device includes parallax problems, and the '809 application is directed to methods of internally/automatically correcting for the alignment offset between visible light line-of-sight between the target area and visible light sensor and infrared line-of-sight between the target area and infrared sensor, to provide a display of both visible and infrared images aligned with one another and superimposed with or overlapping one another such as by using picture-within-picture display means and by using image artifact and edge detection, registration, and alignment image processing techniques. Several other methods to correct for parallax error are described in the '809 application.

New designs for highly portable thermal imaging cameras are desirable that incorporate various form-factor benefits, features, improvements, functionality, reduced complexity, purchase price points, and costs of ownership so as to favorably address the needs for designs better suited for field use to acquire thermal image data for various in-field targets such as HVAC/R systems, power distribution systems, electro-mechanical equipment, electronic circuit boards, and/or other thermal targets.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

For a more complete understanding of the present invention, the drawings herein illustrate examples of the invention. The drawings, however, do not limit the scope of the invention. Similar references in the drawings indicate similar elements.

FIG. 1 illustrates a block diagram of a low cost infrared camera adapted for field thermal imaging applications, according to various embodiments.

FIG. 2 illustrates an exemplary infrared camera especially suited for field use, according to preferred embodiments.

FIG. 3 illustrate a block diagram of a low cost combination visible and infrared camera, according to various embodiments.

FIG. 4 illustrates an exemplary combination visible and infrared camera, according to preferred embodiments.

### DETAILED DESCRIPTION OF PREFERRED EMBODIMENTS

In the following detailed description, numerous specific details are set forth in order to provide a thorough understanding of the preferred embodiments. However, those skilled in the art will understand that the present invention may be practiced without these specific details, that the present invention is not limited to the depicted embodiments, and that the present invention may be practiced in a variety of alternate embodiments. In other instances, well known methods, procedures, components, and systems have not been described in detail.

Preferred embodiments comprise a handheld-sized infrared thermal imaging device (i.e. IR camera) having a focal plane array (FPA) or other type of infrared sensor array, a mini-USB or other communications port, battery power supply, and minimal user interface options such as on/off, IR image capture, and potentially a very basic display. The infrared camera preferably provides a field usable thermal image capture instrument which may be used to capture a thermal image (via its basic IR camera functionality), then later connected to an external computing device such as a laptop computer, with thermal imaging and analysis software running on the external computing device for providing the type of thermal imaging and analysis functionality typical of higher end thermal imaging cameras. In other embodiments, a visual image camera may be added so as to enable visible and IR images to be simultaneously captured and later downloaded to the external computer for analysis.

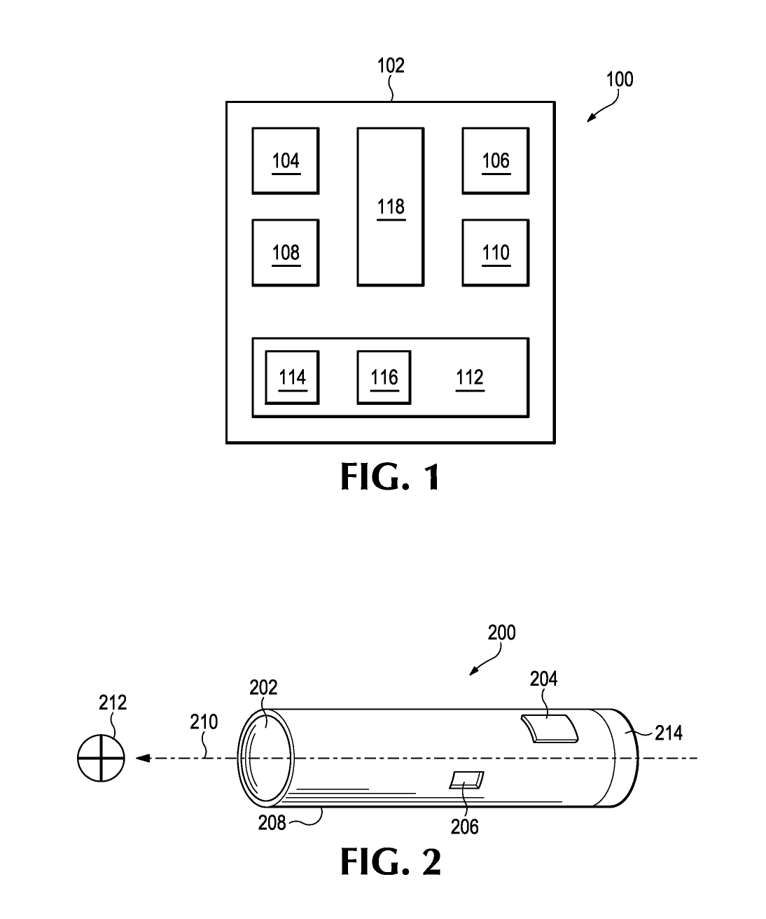

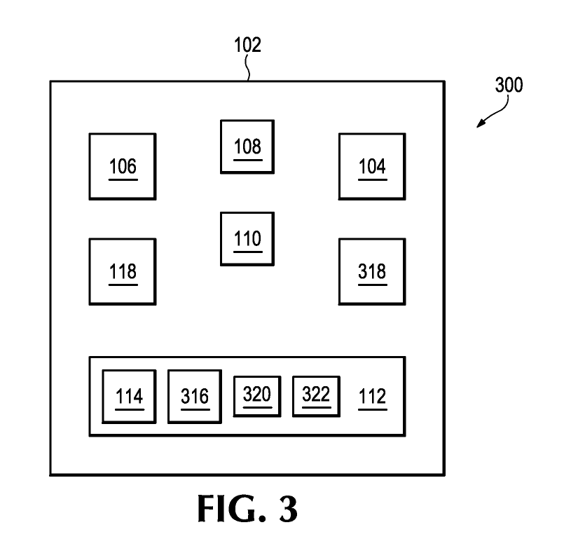

FIG. 1 illustrates a block diagram of a low cost field thermal imager 100 adapted for field thermal imaging applications, according to various embodiments. The field thermal imager 100 preferably comprises a handheld-sized IR camera device 102—a version that comprises just an IR camera (FIG. 1) and a version that also includes a visible light camera (FIG. 3) to compare the two images and perform offline/external thermal analysis. The IR camera device 102 preferably includes focal plane array (FPA) or other type of infrared sensor array 104, a mini-USB or other communications port 106 (or Ethernet or other network connector to allow downloading of images to an external computing device—laptop, desktop, tablet, smartphone, smartwatch, PDA, etc.), battery power supply 110 (with backup or recharging capability via mini-USB or other communications port/connector 106), and a minimal user interface 112.

The user interface 112 preferably includes a minimal number of keys 116 (for on/off, button to take/capture a thermal image, etc.), and, although less preferred, a minimal display 114 for indicating status, possibly showing a rough representation of data viewed by the FPA or IR sensor array 104, and/or LEDs for status indication. In preferred embodiments, user interface 112 comprises an image capture button only, without display or other buttons other than one or more status indicator LEDs. In other embodiments, user interface 112 comprises a minimum number of keys or a simple keypad to take/store the thermal image, select an option to overwrite previously stored images held in memory, etc. In less preferred embodiments, user interface 112 comprises a minimal display as mentioned.

On-board memory 118 for storing saved thermal images is included. Optionally, circuitry adapted for wireless communication 108 may be included for downloading thermal image data to a display device or external computing device for display and analysis of the captured thermal image(s). The wireless means 108 may be via Blue Tooth, Zygbee, Wi-Fi, or other (preferably radio frequency-based) wireless communications means, and may be used for downloading to a smartphone or smartwatch (or laptop, tablet, PDA, etc.) having application software capable of receiving the thermal image data from the field thermal imager 100 for display, analysis, further storage, etc.

The FPA or IR sensor array 104 may comprise a 16×16 array, for example, or 32×32, or 64×64, 128×128, etc. As costs decrease, availability improves, quality improves, etc. lower cost higher resolution FPAs may be used.

FIG. 2 illustrates an exemplary infrared camera 200 especially suited for field use, according to preferred embodiments. As shown, the IR camera 200 preferably includes a cylindrically shaped housing 208 for containing the IR sensor, memory, batteries, etc. as described for FIG. 1. The aperture for the image sensor is preferably positioned at one end 202 and preferably comprises protective optics at the target-facing longitudinal end 202. Preferably aft of a suitably chose (i.e. with sufficient IR transmittance) protective optics are the optics/lens for the IR sensor array. Alternatively, the end aperature 202 may comprise the optics/lens needed for the IR sensor so as to maintain a longitudinally compact and overall small form-factor for the field thermal imager 100.

Longitudinal reference line 210 is shown with the IR optics/lens/aperture 202 directed toward a target area 212. Aft of the target-facing IR optics and sensor array are positioned the battery power supply. Battery access may be just aft of the IR sensor array. However, more preferably the battery access 214 is longitudinally opposite the IR aperture 202, at the rear end of the cylindrical housing 208.

As shown in FIG. 2, push button(s) 204 (preferably one) or other user interface is located along the cylindrical housing 208. Mini-USB (or other downloading, uploading, networking, and/or charging connection) 206 is also preferably positioned along the cylindrical housing 208. Either or both of the button(s) 204 and connector 206 may be positioned longitudinally along the housing 208 differently than shown.

Various methods of leveling and aligning thermal (and visible) images is discussed further below. With reference to the thermal imager 200 as shown in FIG. 2, the orientation of the imager 200 in relation to the target/subject area 212 is preferably addressed post-image capture and download to an external computing device by software running on the external computing device. The thermal image captured for the target area is preferably round and may be manipulated as desired on the external computing device.

The field thermal imager 200 preferably comprises a cylindrical housing 208 that is handheld-sized or smaller, and most preferably shirt pocket-sized. Various mountings may be used such as standard camera tripods, action (Go Pro) camera mountings, and the like.

FIG. 3 illustrate a block diagram of a low cost combination visible and infrared camera 300, according to various embodiments. The field thermal imager 300 preferably comprises a handheld-sized IR camera device 102 of the version that includes an IR camera as in FIG. 1 plus a visible light camera 318 to compare the two images and perform offline/external thermal analysis. The field thermal imager 300 further preferably includes more comprehensive yet still minimized user interface features—button(s) 316 for capturing visible and IR images (simultaneously, or consistent with a selected displayed image), button 320 for selecting display of visible, IR, or both visible and IR images on image display 114, and keys/keypad/mode select 322 preferably usable to (for example, manually through successive key depressions) selectively center/align the displayed (overlayed) visible and IR images.

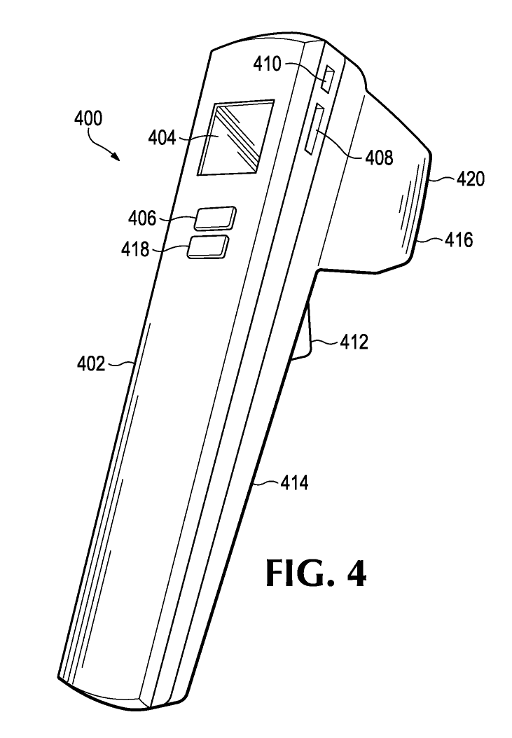

FIG. 4 illustrates an exemplary combination visible and infrared camera 400, according to preferred embodiments. In one embodiment, the IR camera 400 is shaped similar to a conventional infrared thermometer (IRT). As shown, the IR and visible light camera 400 preferably comprises a handheld-sized pistol-grip type housing 402 with a display 404 (114) oppositely positioned from target-facing visible camera optics 420 and target-facing infrared sensor array (i.e. IR camera) optics 416. A mode select button 406 is provided for selection of display modes as described for button 320 in FIG. 3. A mini-USB or other connector 410 is provided, preferably as described for connector 106, 206 in FIGS. 1-3. An SD card or other removable memory slot 408 is preferably provided as shown, to allow for storing visible and/or infrared images (and associated date/time/image reference tag/etc. data) for easy transfer to/from the camera 400. A trigger 412 is preferably used (operable as for button 316) for capturing image(s). Batteries (110) may be positioned in the lower portion of the handle 414. And button(s) 418 are provided for the functionality described for mode select 322 above.

In preferred embodiments, trigger 412 may be used to “freeze” (or temporarily hold) the displayed image(s). The field technician may then review the held image(s) and then determine whether to store the images or take subsequent images (with perhaps adjustments to the target area captured). The range/distance from camera 400 to target area may be, in some embodiments, fairly close proximity. That is, the camera 400 may be preset with fixed focus to distances to a number of feet, configuring the camera 400 for use in relatively close proximity with the target area. The camera preferably includes mode selections to adjust the distance to selectable preset/predetermined ranges—close prox., mid-range, far—and preferably does not include zoom features so as to minimize complexity of use, manufacturing costs, costs of ownership, etc.

Preferably, minimal training is needed for operation of the aforementioned cameras (FIGS. 1-4). The cameras are intended to be simple to use. Nevertheless, there are basic thermal analysis and measurement techniques that may be useful to improve the relevance and value of the thermal images captured for analysis. Some of the methods of operation are listed below.

Different methods to align IR and visible camera images, include, according to various embodiments: 1. Manually adjust the image up and down/side to side using keys/buttons or other user interface keys/keypad/touch screen; 2. By centering each image before taking pictures/images (centering manually by previewing image in the display before taking the image/picture); 3. Same as #2 wherein the user may preview and manually align one or the other IR and/or visible light image via user interface and display; 4. Align manually offline, after downloading to external computing device supporting analysis software; 5. Same as #4 except automatically using analysis software; 6. By pulling out of on-board/internal memory a prior thermal image to align with before taking a subsequent thermal image to be stored; 7. Same as #6 except with visible light images captured at different prior time; 8. As in #6 or #7 except with an image retrieved by field device from SD card or other removable memory means, or by uploading image via USB or other network connector.

Different methods of capturing thermal images and/or visible images, include, according to various embodiments: 1. Manually via user interface or handheld device; 2. Automatically via timed, preset, or preprogrammed schedule selected using user interface and/or uploaded to device via USB and/or other network connection to computing device running analysis software; 3. Same as #2 except may be when wired or wirelessly connected with external computing device running analysis software; 4. Any of #1-3 with handheld device held in place by a tripod or digital camera clamp or other type of mounting hardware; 5. Able to upload or set device for image capture at a scheduled time; 6. Same as #5 or upon predetermined criteria (particular temperature, changed condition, etc.) being met, with device wired or wirelessly remotely controlled via USB or other type of communication connection with computing device running analysis software; 7 Via wirelessly connected computing/analysis device with handheld device preferably including only minimal hardware to capture thermal image and upload wirelessly; 8. Same as #7 preferably not including display so as to minimize cost of IR device; 9. Same as #8 preferably not including user interface beyond on/off button and manual image capture button; 10. Same as #7 preferably recharging battery via USB connection when USB connected to power supply (whether power supply is via computing device or other means such as USB wall charger or the like).

Preferably the thermal analysis software running on the external computing device includes prompts, queues, artificial intelligence functionality, and/or options and features for manual or automatic application of best practices and tricks used in thermal imaging analysis. The best practices and tricks of the trade, so to speak, may include evaluation and analysis of the context of the images captured—i.e. the context of the images when and where captured in terms of time of day, environmental conditions, surrounding thermal radiators, etc.

For example, best practices include: 1. Raising emissivity where possible/where needed using white out or electrical tape; 2. Locate the highest emissivity areas when selecting a target measurement area (such as cavities and certain materials, coated surfaces—oil, grease, dust, corrosion—are higher emissivity areas); and 3. Set emissivity when thermal measurement device allows (down from a typical preset of 0.95, where 1.0 is a perfectly (ideal, theoretical) emitting object and 0.0 is a perfectly absorbing body). Standard black insulation tape has an emissivity of approximately 0.97.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. An infrared (IR) camera adapted to be highly portable for field use comprising:
(a) a focal plane array (FPA) or other type of infrared (IR) sensor array;
(b) internal memory adapted to store saved thermal images formed using data from said IR sensor array;
(c) a mini-USB or other type of communication connector and circuitry adapted to download said thermal images stored in said internal memory and upload programming instructions or software, said communications port enabling said IR camera to connect to an external computing device such as a laptop computer, said computing device running software providing thermal imaging functionality;
(d) one or more batteries;
(e) user interface means including one or more of the following: on/off button, IR image capture button, and a display adapted to indicate image capture status.

2. The IR camera of claim 1 further comprising:
(f) a visual image camera with associated circuitry adapted to allow visible and IR images to be simultaneously captured and stored in said internal memory, and later downloaded via said communication connector to said external computer for thermal analysis.

3. The IR camera of claim 1 wherein said IR camera is contained in its entirety as a handheld-sized or smaller thermal measurement instrument.

4. The IR camera of claim 3 wherein said IR camera is completely self-powered and usable to capture thermal images without tethering or any connection to an external device.

5. The IR camera of claim 2 wherein said IR camera is contained in its entirety as a handheld-sized thermal measurement instrument.

6. The IR camera of claim 5 wherein said IR camera is completely self-powered and usable to capture infrared wavelength and corresponding visible wavelength images without tethering or any connection to an external device.

7. The IR camera of claim 3 wherein said IR camera is contained in its entirety as a shirt pocket-sized or palm-of-the-hand-sized thermal measurement instrument.

8. The IR camera of claim 7 wherein said IR camera is contained in its entirety in a substantially cylindrically shaped housing, with an infrared aperture at one end of said cylindrical housing and directed longitudinally outward away from said housing, and removable access to batteries longitudinally aft of said aperture.

9. The IR camera of claim 5 wherein said IR camera is contained in its entirety in a pistol-grip type handheld-sized thermal measurement instrument.

10. The IR camera of claim 9 wherein said IR camera is shaped similar to a conventional infrared thermometer (IRT) (as shown in FIG. 4).

11. A method of performing low cost thermal image analysis comprising:
(a) capturing a thermal image of a subject/target using a low cost infrared (IR) camera that does not include its own high resolution display, comprehensive user interface, or complex thermal analysis software, programming instructions, or application program;
(b) connecting an external computing device such as a laptop computer to said IR camera via wired or wireless means;
(c) downloading said captured thermal image from said IR camera to said external computing device, the external computing device running thermal analysis software; and
(d) performing thermal analysis on said downloaded captured thermal image using said thermal image analysis software running on said external computing device as a low cost alternative to using more expensive thermal imaging devices or thermal imaging and analysis instruments.

12. The method of claim 11 wherein said low cost IR camera comprises said IR camera in any of claims 1-10.
